(19) United States
(12) Patent Application Publication
(10) Pub. No.: US 2016/0111919 A1
(43) Pub. Date: Apr. 21, 2016

(54) AUTOMATIC SOLAR POWER SYSTEM ISOLATION SWITCH

(71) Applicant: BRIAN PETER SCHAUERTE, CLEARWATER, FL (US)

(72) Inventor: BRIAN PETER SCHAUERTE, CLEARWATER, FL (US)

(73) Assignee: ALEXIE SCHAUERTE, ST.PETERSBURG, FL (US)

(21) Appl. No.: 14/517,869

(22) Filed: Oct. 19, 2014

(51) Int. Cl. H02J 9/06

(52) U.S. Cl. CPC H02J 9/062

(57) ABSTRACT

In the case of solar, wind, or other such resource being chosen as a primary power system (hereafter means “normal state”) of a dwelling or recreational vehicle, this process is for automatic protection or disconnection of the preferred electrical system whenever an alternate power source is applied.

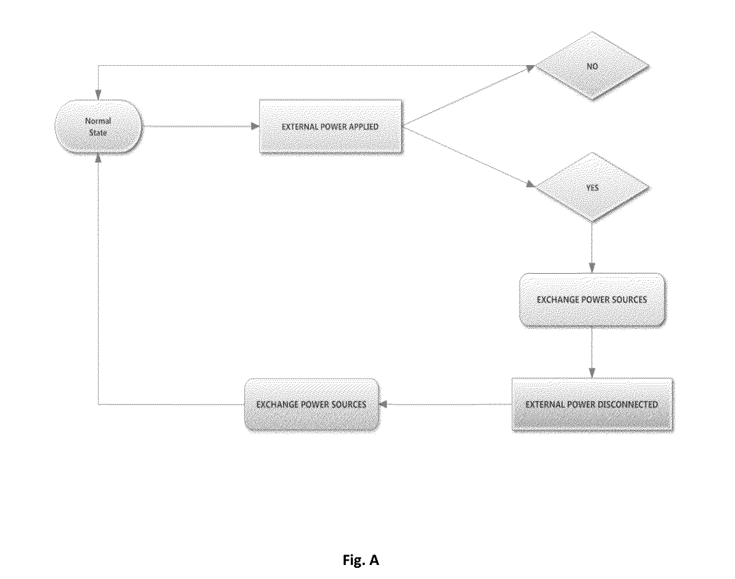

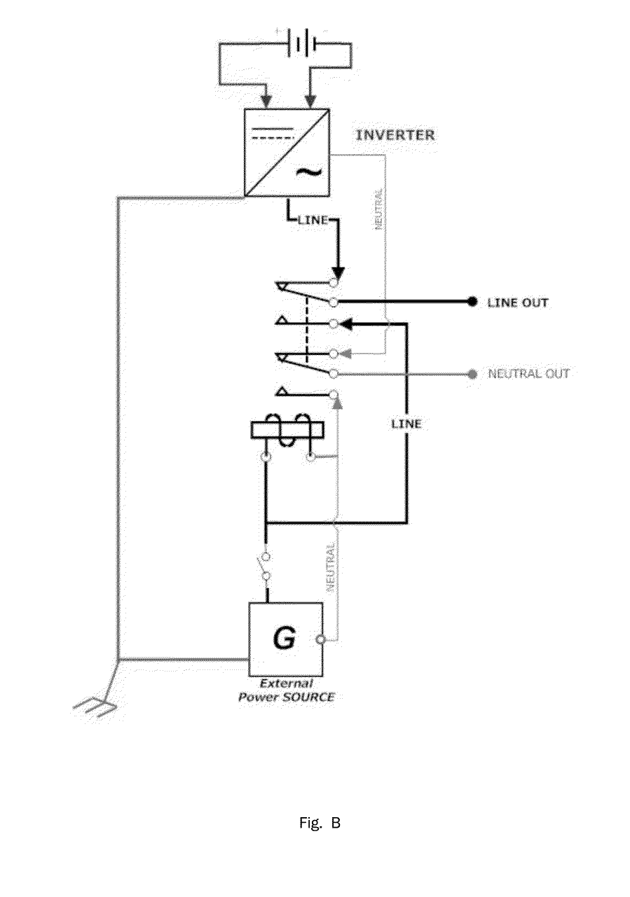

Whenever two power sources may not be applied simultaneously to a normally closed circuit, this process opens the circuit such that the alternate power source may become primary. As an example: Recreational vehicles or other craft, prior to conversion to solar power, normally receive power from a generator or public utility. To modify such a system, this process is inserted into the existing system to temporarily substitute external power to devices within, or devoted to, the existing system without human participation.

### BRIEF DESCRIPTION OF THE DRAWINGS

“Fig.” is to be defined as the word Figure.

Figure A is a flowchart of the process.

Figure B is an electrical schematic of a system.

### DETAILED DESCRIPTION OF THE INVENTION

An inverter is a device that converts electrical direct current (DC) to alternating current (AC). An inverter provides the ability to run AC devices from DC batteries which may be charged by sources such as a solar panel/array. In an independent (off-grid) system, inverters are powered by direct connection to the battery or batteries.

A normally closed (NC) relay will remain as the primary electrical source conductor while it remains in its normal (inactivated) state. (See Figure A)

When external power is applied, this switching process empowers the NC relay, or series of otherwise unpowered relays, resulting in an exchange of power sources and temporary exclusion of the inverter's output from the electrical system.

Whenever the double throw relay's solenoid is energized by an external (secondary) source, the secondary source automatically becomes primary. (See Figure B)

1. No power is consumed by the device in its normal state. When an external power source is applied it empowers a normally closed double throw relay, which takes the primary (default) system offline and temporarily substitutes the new power source.

2. When external power is removed, the relay reverts back to the default power source (its “normal state”) until any external power is reapplied.

3. The process begins at attachments to the inverter's alternating current output terminals (power outlet), and ends at a connection to the input terminals of the domicile's power distribution system (line, neutral, and ground).
